(19) United States
(12) Patent Application Publication
(10) Pub. No.: US 2019/0305633 A1
(43) Pub. Date: Oct. 3, 2019

(54) MOTOR AND CENTRIFUGAL FAN

(71) Applicant: NIDEC SERVO CORPORATION, Kiryu-shi (JP)

(72) Inventors: Koji YONEDA, Kiryu-shi (JP); Makoto WADA, Kiryu-shi (JP)

(21) Appl. No.: 16/286,651

(22) Filed: Feb. 27, 2019

(30) Foreign Application Priority Data
Mar. 30, 2018 (JP) 2018-069756

(51) Int. Cl. H02K 5/22; H02K 9/06; F04D 25/06

(52) U.S. Cl. CPC H02K 5/225; H02K 9/06; H02K 11/33; F04D 25/0646; F04D 25/064

(57) ABSTRACT

A motor includes a rotor including a shaft extending along a central axis, a stator facing the rotor in a radial direction, a circuit board electrically connected to a coil of the stator, a wiring line with one end connected to the circuit board, a base fixed to an attachment object, and a wiring holding portion integrally provided with the base and holding a longitudinal portion of the wiring line. The wiring holding portion includes a first guide portion that guides the wiring line drawn outward in the radial direction from the circuit board in an axial direction along the central axis, and a second guide portion that guides the wiring line guided in the axial direction by the first guide portion outward in the radial direction and restrains displacement of the wiring line outward in the radial direction.

### CROSS REFERENCE TO RELATED APPLICATIONS

This application claims the benefit of priority to Japanese Patent Application No. 2018-069756 filed on Mar. 30, 2018. The entire contents of this application are hereby incorporated herein by reference.

### BACKGROUND OF THE INVENTION

### 1. Field of the Invention

The present disclosure relates to a motor and a centrifugal fan.

### 2. Description of the Related Art

Centrifugal fans (centrifugal type fans) are widely used for cooling, ventilation, air conditioning of household electrical appliances, office automation equipment, industrial equipment, blowers for vehicles, and the like. The centrifugal fan includes an impeller having a plurality of blades disposed in a circumferential direction and a motor for rotating the impeller. Such a motor of the centrifugal fan includes a circuit board for controlling current and the like to be supplied to a stator constituting the motor. One end of a wiring line is connected to the circuit board in order to supply current from an external power supply to the stator, input and output signals to and from an electronic component provided on the circuit board, and the like.

Conventionally, the wiring line connected to the circuit board of the centrifugal fan is fixed to a motor base fixing the motor by using a binding band.

In the centrifugal fan as described above, when the centrifugal fan is incorporated in a product such as an air cleaner, a blower, or the like, another end of the wiring line whose one end is connected to the circuit board is connected to a connector of the product. At this time, when the wiring line is pulled by excessive force, solder at a junction between the wiring line and the circuit board may be peeled. On the other hand, by fixing the wiring line with the binding band, it is possible to suppress the force applied to the junction between the wiring line and the circuit board to some extent. However, the binding band has a certain amount of slackness, and it is difficult to reliably fix the wiring line in its extending direction. Therefore, when the wiring line is pulled in the extending direction, it is desired that peeling of the junction between the wiring line and the circuit board be more reliably suppressed.

Also, at the time of assembling the motor, it is necessary to bind the wiring line with the binding band and to cut off an excess length of the binding band. For this reason, it takes time and labor to fix the wiring line.

Further, when the centrifugal fan is miniaturized in order to reduce size and weight of the product including the centrifugal fan, it is necessary to reduce a gap between the motor and the impeller. Therefore, it is necessary that the wiring line drawn out from the circuit board is also disposed through the small gap between the motor and the impeller. However, in a configuration in which the wiring line is fixed by the binding band, the binding band itself bulges outward in a radial direction. Accordingly, it is necessary to set a gap between the motor and the impeller so as to avoid interference with the binding band, thereby causing an obstacle to downsizing of the centrifugal fan.

### SUMMARY OF THE INVENTION

In an example embodiment of the present disclosure, a motor includes a rotor including a shaft extending along a central axis, a stator facing the rotor in a radial direction, a circuit board electrically connected to a coil of the stator, a wiring line with one end connected to the circuit board, a base fixed to an attachment object, and a wiring holding portion integrally provided with the base and holding a longitudinal portion of the wiring line. The wiring holding portion includes a first guide portion that guides the wiring line drawn outward in the radial direction from the circuit board in an axial direction along the central axis, and a second guide portion that guides the wiring line guided in the axial direction by the first guide portion outward in the radial direction and restrains displacement of the wiring line outward in the radial direction.

One aspect of a centrifugal fan of the present disclosure includes the above-described motor and an impeller connected to the rotor of the motor and rotating around the central axis.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a perspective view showing a centrifugal fan including a motor according to an example embodiment of the present disclosure.

FIG. 2 is a perspective view of the centrifugal fan according to an example embodiment of the present disclosure as viewed from a direction different from that in FIG. 1.

FIG. 3 is a cross-sectional view taken along a central axis of the centrifugal fan according to an example embodiment of the present disclosure.

FIG. 4 is a perspective view showing a portion of an impeller of the centrifugal fan according to an example embodiment of the present disclosure.

FIG. 5 is a perspective view showing a motor according to an example embodiment of the present disclosure.

FIG. 6 is a cross-sectional view taken along a central axis of a motor according to an example embodiment of the present disclosure.

FIG. 7 is a perspective view showing a wiring holding portion provided in a motor of an example embodiment of the present disclosure.

### DETAILED DESCRIPTION OF THE PREFERRED EMBODIMENTS

Scales, numbers, and so on of members or portions illustrated in the following drawings may differ from those of actual members or portions, for the sake of easier understanding of the members or portions. In the following description, one side in a direction parallel to a central axis is referred to as “upper side”, and another side in a direction parallel to the central axis is referred to as “lower side”. It should be noted that the upper side and the lower side are used for explanation only, and are not meant to restrict actual relative positional relationships or directions. Also, unless otherwise explained, a direction parallel with the central axis is simply referred to as “axial direction”, a radial direction having its center on a central axis J is simply referred to as “radial direction”, and a circumferential direction having its center on the central axis J, that is, a direction along a circumference of the central axis J, is simply referred to as “circumferential direction”. Further, in the following description, “in plan view” means a state viewed from the axial direction.

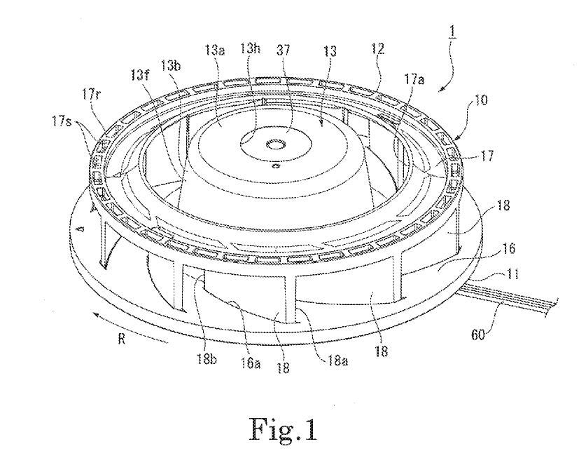

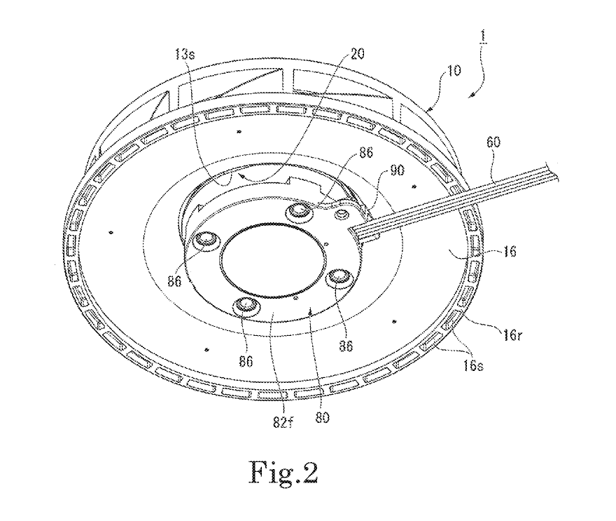

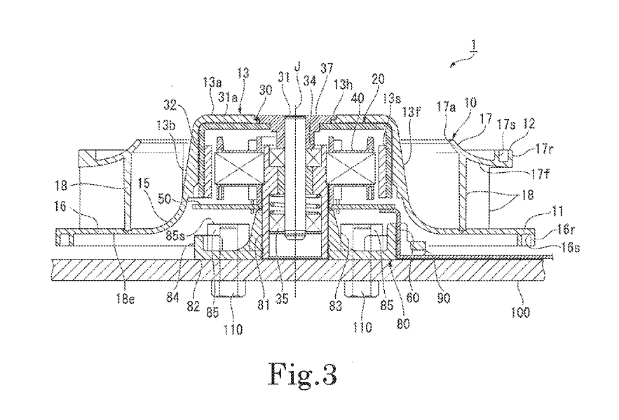

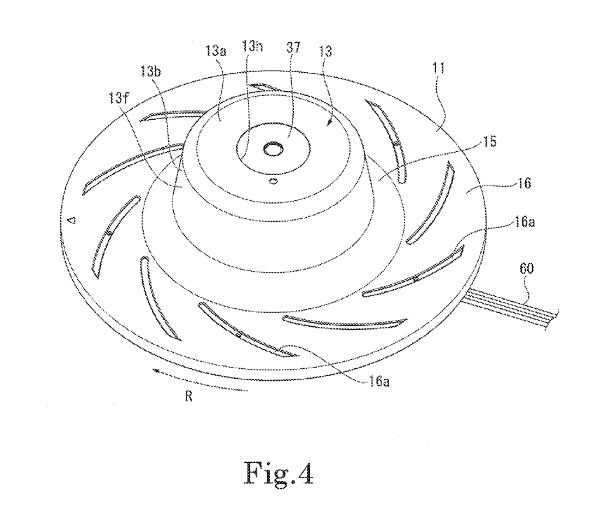

FIG. 1 is a perspective view showing a centrifugal fan including a motor according to the present embodiment. FIG. 2 is a perspective view of the centrifugal fan of the present embodiment as seen from a direction different from that in FIG. 1. FIG. 3 is a sectional view taken along a central axis of the centrifugal fan of the present embodiment. FIG. 4 is a perspective view showing a part of an impeller of the centrifugal fan of the present embodiment.

As shown in FIGS. 1 to 3, a centrifugal fan 1 of the present embodiment includes an impeller 10 rotating about the central axis J, a motor 20, and a base member 80. The centrifugal fan 1 is a centrifugal fan that, by rotation of the impeller 10, sends out air outward in the radial direction by centrifugal force. Each part will be described in detail below.

The impeller 10 includes a first impeller member 11 and a second impeller member 12.

As shown in FIGS. 3 and 4, the first impeller member 11 integrally includes a cup 13, a curved surface 15, and a main plate 16.

The cup 13 has a top plate 13a and a tubular portion 13b. The top plate 13a is formed in a plate shape and disposed in a plane orthogonal to the central axis J (see FIG. 3). A through hole 13h penetrating in the axial direction is provided in a center of the top plate 13a. The tubular portion 13b has a tubular shape extending from an outer peripheral edge on an outer side in the radial direction of the top plate 13a to another side in the axial direction (downward in FIG. 3). An outer diameter of an outer peripheral surface 13f of the tubular portion 13b is gradually enlarged from the top plate 13a toward the other side in the axial direction. The cup 13 has a recess 13s opened on the other side in the axial direction along the central axis J. At least a part of the motor 20 is accommodated in the recess 13s of the cup 13.

The curved surface 15 is provided continuously to the tubular portion 13b of the cup 13. A diameter of the curved surface 15 gradually increases outward in the radial direction toward the other side in the axial direction. The curved surface 15 is a curved surface protruding inward in the radial direction.

The main plate 16 is provided continuously to the outer side in the radial direction of the curved surface 15. The main plate 16 is disposed orthogonally to the central axis J. As shown in FIGS. 2 and 3, on an outer peripheral edge of the main plate 16, a rib 16r continuous in the circumferential direction is provided projecting to the other side in the axial direction. The rib 16r is provided with a plurality of recesses 16s at intervals in the circumferential direction.

As shown in FIGS. 1 and 3, the second impeller member 12 includes a ring 17 and a blade 18.

The ring 17 has an annular shape having an opening 17a in a center. The ring 17 is disposed on one side in the axial direction with respect to the main plate 16 and spaced apart in the axial direction. The ring 17 is disposed closer to the other side in the axial direction (the main plate 16 side) than the top plate 13a of the cup 13.

In the ring 17, a surface 17f on the other side in the axial direction is curved so that a distance in the axial direction from the main plate 16 in the axial direction gradually decreases outward in the radial direction. On an outer peripheral edge of the ring 17, a rib 17r continuous in the circumferential direction is provided so as to protrude to one side in the axial direction. The rib 17r is provided with a plurality of recesses 17s at intervals in the circumferential direction.

A plurality of the blades 18 is disposed on the surface 17f of the ring 17 at intervals in the circumferential direction. Each blade 18 is provided integrally with the ring 17. Each blade 18 extends in the axial direction from the surface 17f of the ring 17 and is fitted into a blade end housing recess 16a provided in the main plate 16. In this way, the plurality of blades 18 is provided between the ring 17 and the main plate 16. Each blade 18 is inclined to an upstream side in a rotation direction R of the impeller 10 with respect to the radial direction (radiation direction) around the central axis J from the inner side in the radial direction to the outer side in the radial direction. In other words, the rotation direction R of the impeller 10 is a direction from a position of a radially outer end 18a of the blade 18 to a position of a radially inner end 18b of the blade 18 in the circumferential direction around the central axis J.

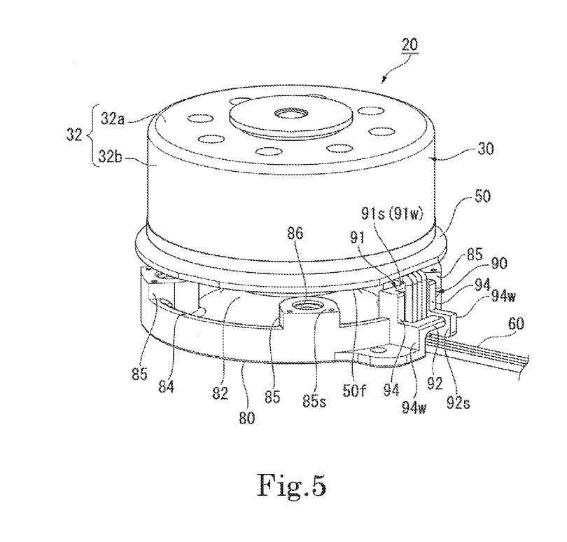

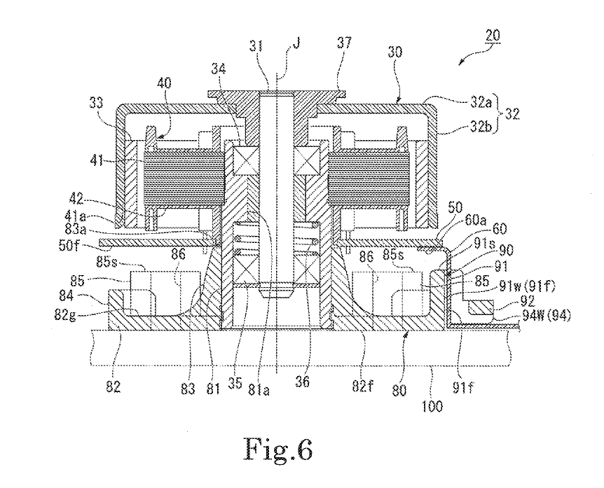

FIG. 5 is a perspective view showing the motor of the present embodiment. FIG. 6 is a cross-sectional view taken along the central axis of the motor of the present embodiment.

As shown in FIGS. 5 and 6, the motor 20 includes a rotor 30, a stator 40, and a circuit board 50.

As shown in FIG. 6, the rotor 30 includes a shaft 31 extending along the central axis J, a rotor case 32, and a permanent magnet 33.

The shaft 31 extends in the axial direction along the central axis J. The shaft 31 is supported by a sleeve 81 fixed to the base member 80. The sleeve 81 has a tubular shape extending in a direction of the central axis J, and holds bearings 34, 35 inside. The shaft 31 is rotatably supported around the central axis J by the bearings 34, 35. On an inner peripheral surface of the sleeve 81, a protrusion 81a protruding inward in the radial direction is provided between the bearings 34 and 35. Between the protrusion 81a and the bearing 35, a coil spring 36 for pressing the bearing 35 to the base member 80 side on the other side in the axial direction is provided.

The rotor case 32 is held on the shaft 31 protruding from the sleeve 81 to the one side in the axial direction via a bush 37. The rotor case 32 integrally includes a disk 32a extending perpendicularly to the central axis J outward in the radial direction and a cylinder 32b extending from an outer peripheral edge of the disk 32a to the other side in the axial direction.

The permanent magnet 33 is fixed to an inner peripheral surface of the rotor case 32. A plurality of permanent magnets 33 is provided in the circumferential direction around the central axis J.

The stator 40 is located on an inner side in the radial direction of the rotor 30 and faces the permanent magnet 33 of the rotor 30 in the radial direction. The stator 40 includes a stator core 41, an insulator 42, and a coil (not shown).

The stator core 41 is provided on an outer peripheral surface of the sleeve 81. The stator core 41 is provided in a tubular shape as a whole by laminating a plurality of annular steel plates in the axial direction. The stator core 41 has a plurality of teeth 41a provided at equal intervals in the circumferential direction. Each tooth 41a extends outward in the radial direction.

The insulator 42 is provided so as to cover the teeth 41a. A coil (not shown) is wound around the teeth 41a via the insulator 42.

The circuit board 50 is electrically connected to the coil (not shown) of the stator 40 and supplies current to the coil. The circuit board 50 is in the form of a plate and is disposed in a plane orthogonal to the central axis J. The circuit board 50 is provided on the other side in the axial direction along the central axis J with respect to the rotor 30 and the stator 40. The circuit board 50 is sandwiched between an end of the insulator 42 and a holding cylinder 83 of the base member 80 which will be described later.

As shown in FIGS. 5 and 6, in order to supply current from an external power supply, input and output control signals to and from an electronic component mounted on the circuit board 50, and the like, a wiring line 60 is connected to the circuit board 50. A plurality of wiring lines 60 are bundled and formed into a band shape. One end 60a of the wiring line 60 is joined by soldering to a board surface 50f facing the other side in the axial direction of the circuit board 50. It is to be noted that the one end 60a of the wiring line 60 may be connected to a connector provided on the board surface 50f of the circuit board 50.

As shown in FIG. 3, such a motor 20 is disposed by inserting the rotor case 32 of the rotor 30 into the recess 13s provided in the cup 13 of the impeller 10. The rotor case 32 is fixed by press-fitting and bonding to an inner diameter of the cup 13 so that the disk 32a abuts against the top plate 13a of the cup 13. As a result, the rotor 30 and the stator 40 of the motor 20 are housed inside the cup 13. Further, the circuit board 50 is disposed on the inner side in the radial direction of the curved surface 15.

The base member 80 is disposed on the other side in the axial direction with respect to the main plate 16 of the impeller 10. The base member 80 is fixed to an attachment object 100 in which the centrifugal fan 1 is incorporated, for example, a casing of an air cleaner. As shown in FIGS. 5 and 6, the base member 80 has a plate-like base plate 82 provided perpendicularly to the central axis J. The base plate 82 is provided on a side apart from the recess 13s with respect to the circuit board 50. The base plate 82 has an attachment surface 82f abutting on the attachment object 100 on the other side in the axial direction.

In the base plate 82, the tubular holding cylinder 83 protruding on the one side in the axial direction is provided at a center of a surface 82g on a side opposite to the attachment surface 82f. An end of the sleeve 81 is inserted and held inside the holding cylinder 83. Further, on an outer peripheral edge of the base plate 82, a rib 84 protruding to the one side in the axial direction and continuous in the circumferential direction is integrally provided.

The base member 80 includes a plurality of bosses 85 at equal intervals in the circumferential direction. The boss 85 protrudes from the surface 82g of the base plate 82 to the one side in the axial direction (the circuit board 50 side). As shown in FIG. 3, a tip 85s of the boss 85 protrudes from the base plate 82 toward the recess 13s more than an end 18e on the base plate 82 side in the axial direction of the blade 18 of the impeller 10.

As shown in FIGS. 5 and 6, the boss 85 is provided so as to overlap a part of the rib 84. In the boss 85, the tip 85s on the one side in the axial direction (upper side) is located closer to the other side in the axial direction (lower side) than a tip 83a on the one side in the axial direction of the holding cylinder 83. As a result, the boss 85 is spaced apart in the axial direction from the circuit board 50 that abuts against the tip 83a of the holding cylinder 83.

Between the bosses 85 adjacent to each other in the circumferential direction, a distance in the axial direction between the rib 84 and the circuit board 50 is larger than a distance in the axial direction between the boss 85 and the circuit board 50.

The boss 85 is provided with a female screw hole 86 passing through the base plate 82 and the boss 85 in the axial direction. A screw member 110 (see FIG. 3) for connecting the base member 80 to the attachment object 100 is screwed into the female screw hole 86 while the attachment surface 82f of the base plate 82 abuts against the attachment object 100.

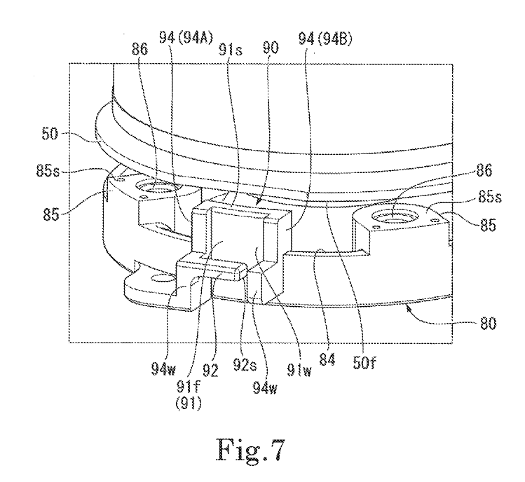

FIG. 7 is a perspective view showing a wiring holding portion provided in the motor of the present embodiment.

As shown in FIGS. 5 to 7, on an outer periphery of the base member 80, a wiring holding portion 90 that holds a part in a longitudinal direction of the wiring line 60 is provided integrally with the base member 80. The wiring holding portion 90 includes a first guide portion 91, a second guide portion 92, and a side guide wall (cross direction displacement restraining portion) 94.

The first guide portion 91 has a wall-shaped portion 91w protruding from the base member 80 along the axial direction to the circuit board 50 side on the one side in the axial direction. The first guide portion 91 guides the wiring line 60 having one end 60a connected to the board surface 50f of the circuit board 50 and extending outward in the radial direction, by bending the wiring line 60 at a tip 91s of the wall-shaped portion 91w so that the wiring line 60 extends to the other side in the axial direction. The wiring line 60 bent at the tip 91s of the wall-shaped portion 91w is guided so as to extend to the other side in the axial direction along an outer surface 91f facing outward in the radial direction of the wall-shaped portion 91w.

The side guide wall 94 protruding outward in the radial direction is provided on both sides of the first guide portion 91 in a cross direction crossing the axial direction and the radial direction. The side guide wall 94 protrudes more outward in the radial direction than the outer surface 91f of the first guide portion 91. The side guide wall 94 restrains displacement of the wiring line 60 along the outer surface 91f of the wall-shaped portion 91w in the cross direction. A protruding guide wall 94w protruding further outward in the radial direction than an outer side in the radial direction of the side guide wall 94 is provided at an end on the other side in the axial direction thereof.

The second guide portion 92 has a base end joined to a protruding guide wall 94w of one guide wall 94A, of the side guide walls 94 on both sides of the first guide portion 91, and extends toward another guide wall 94B in a direction crossing the axial direction and the radial direction. The second guide portion 92 is disposed at a space outward in the radial direction with respect to the outer surface 91f of the wall-shaped portion 91w. The second guide portion 92 bends the wiring line 60 along the outer surface 91f of the wall-shaped portion 91w at another end in the axial direction of the wall-shaped portion 91w and guides the wiring line 60 outward in the radial direction. The second guide portion 92 restrains radially outward displacement of the wiring line 60 extending in the axial direction along the outer surface 91f of the first guide portion 91.

A tip of the second guide portion 92 separates from the guide wall 94B by a gap 92s. Through the gap 92s, the wiring line can be inserted and withdrawn between an outer peripheral surface of the wall-shaped portion 91w and the second guide portion 92.

In the centrifugal fan 1 having the above-described configuration, when the impeller 10 rotates around the central axis J by driving of the motor 20, air blowing is performed by sending air (fluid) outward in the radial direction by centrifugal force. The air is sucked in the axial direction from a gap between the cup 13 and the opening 17a of the ring 17. The sucked air smoothly changes its flow direction outward in the radial direction from the axial direction along the outer peripheral surface 13f of the tubular portion 13b of the cup 13 and the curved surface 15, and flows between the ring 17 and the main plate 16. Between the ring 17 and the main plate 16, the air is sent outward in the radial direction by the plurality of blades 18.

The wiring holding portion 90 of the present embodiment includes the first guide portion 91 for axially guiding the wiring line 60 drawn outward in the radial direction from the circuit board 50 and the second guide portion 92 for guiding the wiring line 60 axially guided by the first guide portion 91 outward in the radial direction and for restraining displacement of the wiring line 60 outward in the radial direction. Thus, when the wiring line 60 having the one end 60a connected to the circuit board 50 is pulled in an extending direction from another end side of the wiring line 60, the wiring line 60 is pressed against the first guide portion 91 and the second guide portion 92 that change a direction of the extending direction. Therefore, frictional force is generated between the wiring line 60 and the first guide portion 91 and the second guide portion 92, and it is possible to suppress displacement of the wiring line 60 in the extending direction.

Therefore, force acting on a junction between the circuit board 50 and the wiring line 60 drawn out from the circuit board 50 can be suppressed more reliably, and the wiring line 60 can be prevented from peeling from the circuit board 50.

In addition, since the first guide portion 91 and the second guide portion 92 are provided integrally with the base member 80, there is no need to use a binding band. Therefore, it is possible to improve assembling workability of the motor 20.

Furthermore, since the second guide portion 92 suppresses the displacement of the wiring line 60 outward in the radial direction, it is possible to reduce a gap between the motor 20 and the impeller 10, thereby downsizing the centrifugal fan 1.

According to the motor 20 of the present embodiment, the wiring line 60 is caused to run along the outer surface 91f that faces outward in the radial direction from the tip 91s of the wall-shaped portion 91w by the first guide portion 91, thereby guiding the wiring line 60 in the axial direction. When the wiring line 60 is pulled in the extending direction, the wiring line 60 is pressed against the tip 91s of the wall-shaped portion 91w to generate frictional force, and displacement of the wiring line 60 in the extending direction is suppressed.

Further, according to the motor 20 of the present embodiment, the second guide portion 92 is disposed outward in the radial direction with respect to the outer surface 91f of the wall-shaped portion 91w, and extends in the direction crossing the axial direction and the radial direction. As a result, the wiring line 60 guided in the axial direction along the outer surface 91f of the wall-shaped portion 91w is guided outward in the radial direction by the second guide portion 92. When the wiring line 60 is pulled in the extending direction, the wiring line 60 is pressed against the second guide portion 92 to generate frictional force, and displacement of the wiring line 60 in the extending direction is suppressed.

According to the motor 20 of the present embodiment, the second guide portion 92 has the gap 92s for inserting and withdrawing the wiring line 60 between the outer peripheral surface of the wall-shaped portion 91w and the second guide portion 92. Accordingly, the wiring line 60 can be easily detached from the wiring holding portion 90 provided integrally with the base member 80.

Further, according to the motor 20 of the present embodiment, the side guide wall 94 can constrain displacement of the wiring line 60 in the cross direction crossing the axial direction and the radial direction.

Further, according to the motor 20 of the present embodiment, the side guide wall 94 protrudes more outward in the radial direction than the wiring line 60 in which the radially outward displacement is restrained by the second guide portion 92. Thereby, it is possible to protect the wiring line 60, and it is possible to suppress occurrence of disconnection or the like of the wiring line 60 due to interference of other parts with the wiring line 60.

Further, according to the motor 20 of the present embodiment, the boss 85 having the female screw hole 86 for connecting the base plate 82 to the attachment object 100 protrudes from the surface 82g of the base plate 82 to the recess 13s side more than the end 18e on the base plate 82 side of the blade 18 of the impeller 10. As a result, it is possible to sufficiently secure an axial length of the female screw hole 86 provided in the boss 85 without causing the boss 85 to protrude from the base plate 82. Therefore, the screw member 110 for connecting the base plate 82 to the attachment object 100 is securely fastened to the female screw hole 86, the centrifugal fan 1 is firmly fixed to the attachment object 100, and the motor 20 can be miniaturized.

Further, according to the motor 20 of the present embodiment, the boss 85 is provided with a space between the boss 85 and the circuit board 50. As a result, it is possible to secure a gap in which no electrical short circuit occurs between the screw member 110 screwed into the female screw hole 86 of the boss 85 and the circuit board 50.

Further, according to the motor 20 of the present embodiment, between the bosses 85 adjacent to each other in the circumferential direction, a larger space is provided between the rib 84 and the circuit board 50 than the space between the boss 85 and the circuit board 50. Thus, air circulation between the base plate 82 and the circuit board 50 can be enhanced through the space between the bosses 85 adjacent to each other in the circumferential direction.

Further, according to the motor 20 of the present embodiment, the wiring line 60 drawn out from the circuit board 50 can be routed along the attachment surface 82f of the base plate 82 without contacting the impeller 10 (the first impeller member 11). Thereby, the attachment surface 82f and the first impeller member 11 can be brought close to each other in the axial direction. Therefore, according to the centrifugal fan 1 provided with the motor 20, a thickness in the axial direction can be suppressed. Therefore, the centrifugal fan 1 can be disposed in a limited space inside a casing of an air cleaner or the like which is the attachment object 100. As a result, it is possible to reduce a size of the air cleaner itself including the centrifugal fan 1.

While one embodiment of the present disclosure has been described above, it will be understood that features, a combination of the features, and so on according to the embodiment are only illustrative and not restrictive, and that an addition, elimination, and substitution of a feature(s), and other modifications can be made without departing from the scope and spirit of the present disclosure. Also, note that the present disclosure is not limited by the embodiment.

For example, use of the motor 20 and the centrifugal fan 1 described in the above embodiment is not particularly limited.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A motor comprising:
a rotor including a shaft extending along a central axis;
a stator facing the rotor in a radial direction;
a circuit board electrically connected to a coil of the stator;
a wiring line with one end connected to the circuit board;
a base fixed to an attachment object; and
a wiring holding portion integrally provided with the base and holding a portion in a longitudinal direction of the wiring line; wherein
the wiring holding portion includes a first guide portion that guides the wiring line drawn outward in the radial direction from the circuit board in an axial direction along the central axis, and a second guide portion that guides the wiring line guided in the axial direction by the first guide portion outward in the radial direction and restrains displacement of the wiring line outward in the radial direction.

2. The motor according to claim 1, wherein the first guide portion includes a wall-shaped portion protruding from the base toward the circuit board along the axial direction, and guides the wiring line in the axial direction by running the wiring line from a tip of the wall-shaped portion along an outer surface facing outward in the radial direction.

3. The motor according to claim 2, wherein the second guide portion is disposed outward in the radial direction with respect to the outer surface of the wall-shaped portion, and extends in a direction crossing the axial direction and the radial direction.

4. The motor according to claim 1, wherein on both sides in a cross direction crossing the axial direction and the radial direction of the first guide portion and the second guide portion, a cross direction displacement restraining portion that restrains displacement of the wiring line in the cross direction is provided.

5. The motor according to claim 4, wherein the cross direction displacement restraining portion protrudes more outward in the radial direction than the wiring line where outward displacement in the radial direction is restrained by the second guide portion.

6. A centrifugal fan comprising:
the motor according to claim 1; and
an impeller connected to the rotor of the motor and rotatable around the central axis.
